(19) United States
(12) Patent Application Publication
(10) Pub. No.: US 2026/0257495 A1
(43) Pub. Date: Sep. 3, 2026

(54) PRINTING APPARATUS

(71) Applicant: FUJIFILM Corporation, Tokyo (JP)

(72) Inventors: Masaru FUJIE, Saitama (JP); Masakatsu KUBOTA, Saitama (JP)

(73) Assignee: FUJIFILM Corporation, Tokyo (JP)

(21) Appl. No.: 19/549,236

(22) Filed: Feb. 25, 2026

(30) Foreign Application Priority Data
Feb. 28, 2025 (JP) 2025-032203

(51) Int. Cl. B41J 3/54; B41J 3/407; B41J 13/10; B41J 13/12; B41J 25/34; B41J 29/13

(52) U.S. Cl. CPC B41J 3/54; B41J 3/407; B41J 13/106; B41J 13/12; B41J 25/34; B41J 29/13

(57) ABSTRACT

A printing apparatus includes a housing, a plurality of printer units, and at least one accommodation portion that attachably and detachably accommodates at least one of the plurality of printer units and that is displaceable with respect to the housing.

### CROSS-REFERENCE TO RELATED APPLICATIONS

The present application claims priority under 35 U.S.C. § 119 to Japanese Patent Application No. 2025-032203, filed on Feb. 28, 2025. The above application is hereby expressly incorporated by reference, in its entirety, into the present application.

### BACKGROUND

### 1. Technical Field

The present disclosure relates to a printing apparatus.

### 2. Description of the Related Art

A photo printing vending machine is known in which a plurality of printer units are attachably and detachably mounted in one housing (for example, see JP4089144B and JP2003-203271A). Each printer unit described in JP4089144B is mounted on a slide rail provided on an inner wall of the housing.

### SUMMARY

The technology of the present disclosure provides a printing apparatus in which a printer unit is more easily attached and detached than in the related art.

A printing apparatus according to the present disclosure includes a housing, a plurality of printer units, and at least one accommodation portion that attachably and detachably accommodates at least one of the plurality of printer units and that is displaceable with respect to the housing.

The accommodation portion may be capable of accommodating the plurality of printer units.

The accommodation portion may include an accommodation space that accommodates the plurality of printer units.

A plurality of the accommodation portions may be provided.

The accommodation portion may include an adjustment mechanism that is capable of adjusting according to a type of the printer unit.

The accommodation portion may be a tray or an openable and closable door.

The tray may be a drawer type.

A plurality of the trays or the doors, which are selectively used according to a type may be provided.

A direction in which the tray is pulled out may be the same as a discharge direction in which the printer unit accommodated in the tray discharges a recording medium.

The printer unit may be attached to the accommodation portion in a posture in which a recording surface of the recording medium to be discharged faces a front side of the housing.

The plurality of printer units may be arranged in a height direction of the housing.

The accommodation portions may be respectively provided on both side surfaces of the housing.

The accommodation portion may include a restriction mechanism that restricts displacement of the printer unit.

The restriction mechanism may be a locking mechanism, and may include a plurality of locking pins.

### BRIEF DESCRIPTION OF THE DRAWINGS

FIG. 1 is a diagram showing an example of a usage aspect of a printing apparatus.

FIG. 2 is a perspective view of the printing apparatus in a state in which an accommodation tray is pulled out.

FIG. 3 is a front view of the printing apparatus in a state in which the accommodation tray is pulled out.

FIG. 4 is a diagram showing a schematic configuration of the accommodation tray.

FIG. 5 is a diagram showing a printing apparatus of Modification Example 1.

FIG. 6 is a diagram showing a printing apparatus of Modification Example 2.

FIG. 7 is a diagram showing a printing apparatus of Modification Example 3.

FIG. 8 is a diagram showing a printing apparatus of Modification Example 4.

FIG. 9 is a diagram showing a printing apparatus of Modification Example 5.

FIG. 10 is a diagram showing a printing apparatus of Modification Example 6.

FIG. 11 is a diagram showing a printing apparatus of Modification Example 7.

### DETAILED DESCRIPTION

Hereinafter, an example of an embodiment of the technology of the present disclosure will be described with reference to the drawings. The same or equivalent components and parts in the respective drawings are denoted by the same reference numerals, and the duplicated description will be omitted. Furthermore, dimensional ratios in the drawings are exaggerated for convenience of description, and may be different from the actual ratios.

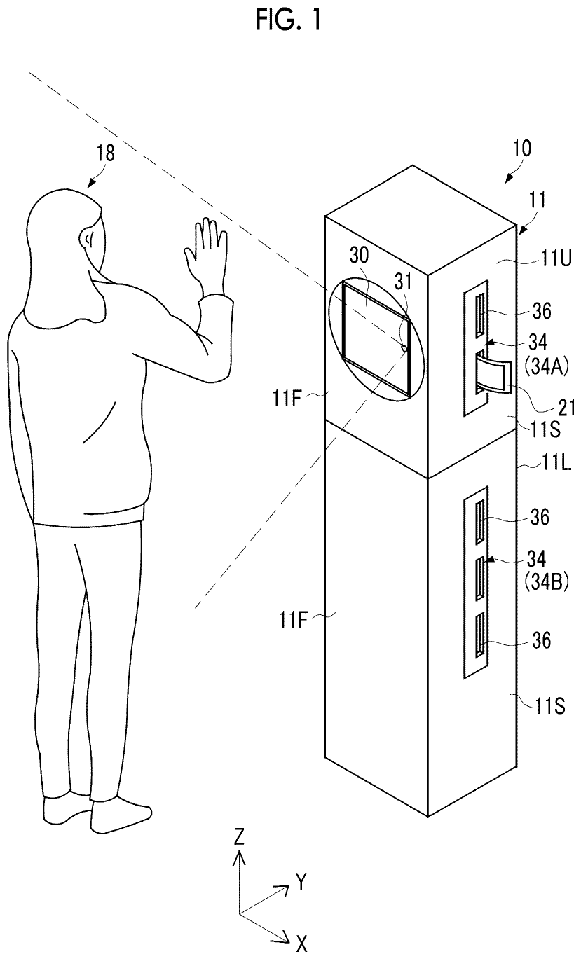

An example of a configuration of a printing apparatus 10 according to the present embodiment will be described with reference to FIGS. 1 to 4. The printing apparatus 10 is installed, for example, at a storefront of a retail store, in tourist facilities, in game centers, and the like. The printing apparatus 10 provides a printing service related to printing of an image to a user 18. The printing service is, for example, a service of capturing the user 18 in front of the printing apparatus 10, printing the captured image on a recording medium 21, and providing the printed recording medium 21 to the user 18 as a photo print. The printing service may be a service of printing an image provided by the user 18 on the recording medium 21 without performing capturing.

In FIG. 1, a Z direction is a height direction of the printing apparatus 10, an X direction is a width direction of the printing apparatus 10, and a Y direction is a depth direction of the printing apparatus 10. A housing 11 of the printing apparatus 10 has, for example, a rectangular parallelepiped shape, and an operation panel 30 is provided on a front surface 11F. The operation panel 30 is, for example, a touch panel display that can display a display screen for displaying an operation screen and an image. The operation panel 30 is also provided with a camera 31 that captures the user 18. A discharge port 36 that discharges the recording medium 21 is provided on a side surface 11S of the housing 11. In addition, for example, the housing 11 is composed of an upper housing 11U and a lower housing 11L, and the upper housing 11U and the lower housing 11L can be separated from each other. A front surface and a side surface of each of the upper housing 11U and the lower housing 11L are each a part of the front surface 11F and the side surface 11S of the housing 11, and are designated by the same reference numerals.

The printing apparatus 10 includes the housing 11 and a plurality of printer units 50. The housing 11 includes at least one accommodation tray 34 that accommodates at least one printer unit 50, and the accommodation tray 34 is displaceable with respect to the housing 11.

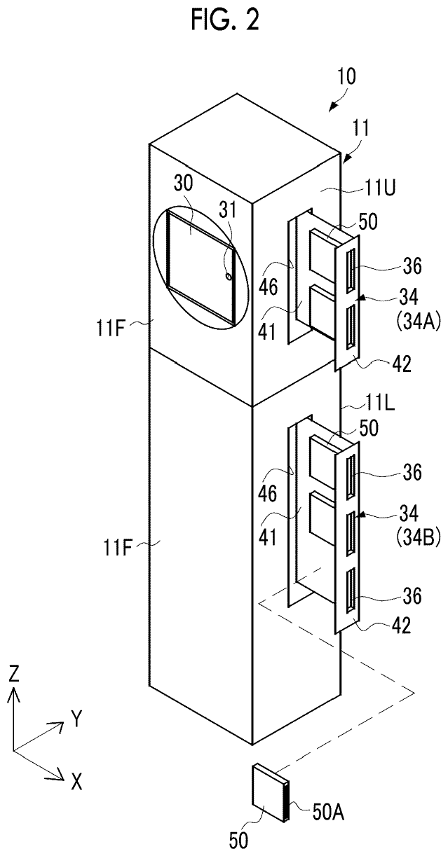

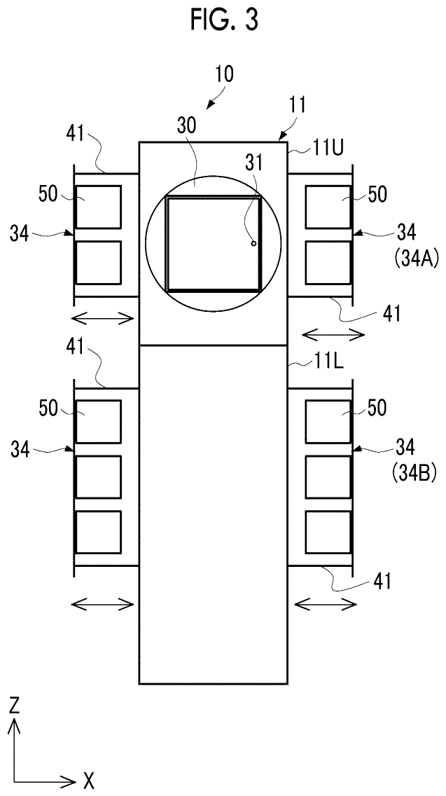

In the present example, as shown in FIGS. 2 and 3, the housing 11 includes four accommodation trays 34. Two accommodation trays 34 are provided in each of the upper housing 11U and the lower housing 11L. One accommodation tray 34 is provided on each side surface 11S side of the upper housing 11U and the lower housing 11L. That is, the accommodation trays 34 are respectively provided on both side surfaces 11S of the housing 11. Here, for convenience, the accommodation tray 34 provided in the upper housing 11U may be referred to as an accommodation tray 34A, and the accommodation tray 34 provided in the lower housing 11L may be referred to as an accommodation tray 34B. In a case where the distinction is not necessary, both are simply referred to as the accommodation tray 34.

As shown in FIGS. 2 and 3, the accommodation trays 34A respectively provided on both side surfaces 11S of the upper housing 11U can accommodate two printer units 50. In addition, the accommodation trays 34B respectively provided on both side surfaces 11S of the lower housing 11L can accommodate three printer units 50. The plurality of printer units 50 are arranged in the height direction of the housing 11.

The accommodation tray 34 is composed of a plate 41 and a cover 42. The plate 41 functions as a tray body that accommodates the printer unit 50. The cover 42 is provided at one end of the plate 41. The accommodation tray 34 is displaced between a storage position at which the printer unit 50 is stored in the housing 11 and an attachment/detachment position at which the plate 41 is exposed to the outside of the housing 11 and the printer unit 50 is attachable and detachable.

The plate 41 has, for example, a rectangular shape. The plate 41 has an area corresponding to the number of the plurality of printer units 50 to be accommodated. That is, the plate 41 has an accommodation space that accommodates the plurality of printer units 50. The plate 41 of the accommodation tray 34A has an accommodation space that accommodates two printer units 50, and the plate 41 of the accommodation tray 34B has an accommodation space that accommodates three printer units 50. For example, a peripheral wall may be provided on an outer edge of the plate 41 such that the accommodation space is surrounded by the peripheral wall.

The cover 42 has the same size and shape as an opening portion 46 of the housing 11, and constitutes a part of the side surface 11S of the housing 11 in a case where the accommodation tray 34 is in a storage state. The discharge port 36 is formed in the cover 42. Although not shown, a grip portion or the like for performing a pulling-out operation is provided on the cover 42.

The printer unit 50 is, for example, a printer that uses an instant film as the recording medium 21. As the printer unit 50, for example, a commercially available product usable as a mobile printer that can be carried alone may be used.

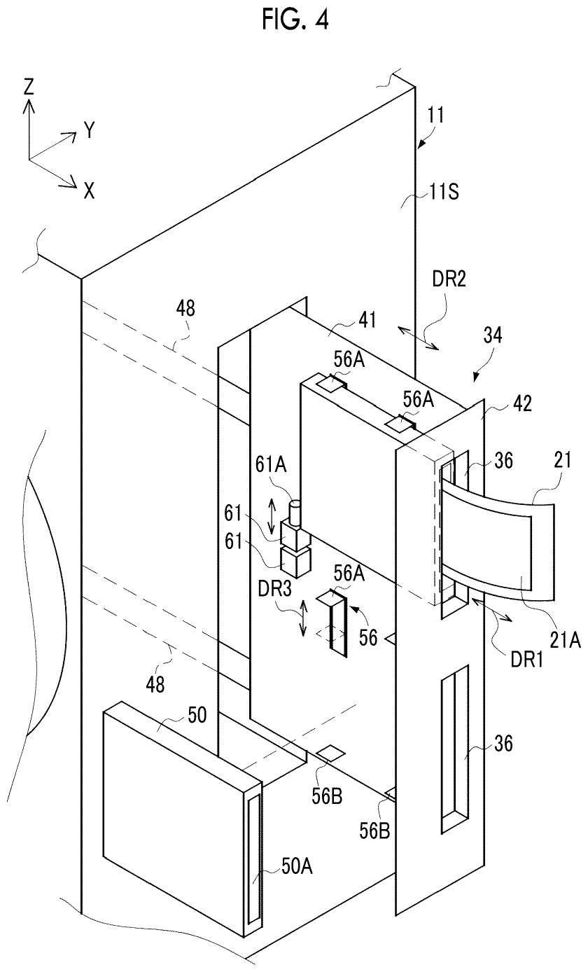

As shown in FIG. 4, the printer unit 50 is provided with a discharge port 50A that discharges the recording medium 21. The printer unit 50 is mounted in the accommodation tray 34 in a posture in which the discharge port 36 of the cover 42 and the discharge port 50A of the printer unit 50 correspond to each other. With this configuration, the recording medium 21 discharged from the discharge port 50A of the printer unit 50 can be discharged from the discharge port 36 of the cover 42.

In addition, the accommodation tray 34 is, for example, slidably attached to a rail 48 provided in the housing 11. For example, the rail 48 engages with a groove formed on a bottom surface of the plate 41 of the accommodation tray 34. The accommodation tray 34 is a drawer type that can be pulled out to the outside of the housing 11 by sliding along the rail 48. The rail 48 extends in the X direction that is the width direction of the housing 11, and the accommodation tray 34 is pulled out to the side of the housing 11.

In addition, a pulling-out direction (DR2 in FIG. 4) of the accommodation tray 34 is the same as a discharge direction (DR1 in FIG. 4) of the recording medium 21 discharged by the printer unit 50 accommodated in the accommodation tray 34. In the present example, both the pulling-out direction DR2 and the discharge direction DR1 are the width direction (that is, the X direction) of the housing 11. The printer unit 50 is attached to the accommodation tray 34 in a posture in which a recording surface 21A of the recording medium 21 to be discharged faces the front side of the housing 11. The posture in which the recording surface 21A faces the front side of the housing 11 is a posture in which the recording surface 21A faces a front surface 11F side in a front-rear direction (that is, the Y direction) of the housing 11. The front side may be in a direction parallel to the XY plane or may be slightly inclined. That is, the orientation of the recording surface 21A may be slightly inclined upward or downward. That is, an error in the orientation of the recording surface 21A within a range that can be visually recognized by the user 18 who stands facing the front surface 11F of the housing 11 is allowed.

In addition, the accommodation tray 34 includes an adjustment mechanism 56 that is capable of adjusting according to a type of the printer unit 50. The adjustment mechanism 56 is composed of, for example, a movable fitting 56A and a fixed fitting 56B that sandwich the printer unit 50 from opposite directions. The movable fitting 56A and the fixed fitting 56B are disposed to face each other in the width direction of the accommodation tray 34, that is, the height direction (Z direction in FIG. 4) of the housing 11. The printer unit 50 is accommodated between the movable fitting 56A and the fixed fitting 56B and is held by being sandwiched by these fittings. The movable fitting 56A is an L-shaped fitting that is slidable in a direction (Z direction in FIG. 4) indicated by DR3. The movable fitting 56A has a strip-shaped bottom portion and an engaging portion that is bent at 90°with respect to the bottom portion. The movable fitting 56A is disposed such that the bottom portion is inserted into an opening formed in the plate 41 and the bottom surface is parallel to a surface of the plate 41. The movable fitting 56A is attached in a state in which the engaging portion protrudes from the opening. The engaging portion protruding from the opening faces the fixed fitting 56B and sandwiches the printer unit 50 from both sides. By sliding the movable fitting 56A, a plurality of types of printer units 50 having different body sizes or body shapes can be accommodated.

The printer unit 50 uses a recording medium 21 having different sizes, and in a case where the sizes of the recording medium 21 are different, the body size or the body shape may be different. In addition, even in a case where the sizes of the recording medium 21 are the same, the body size or the body shape may be different due to the difference in type. In addition, even in a case of using the same recording medium 21, the body size of the printer unit 50 may be different due to a difference in the number of recording media 21 to be accommodated. The type of the printer unit 50 is a concept including at least one difference in the body size or the body shape.

In addition, the accommodation tray 34 includes a restriction mechanism 61 that restricts displacement of the printer unit 50. The restriction mechanism 61 is, for example, a solenoid having a plunger 61A. The plunger 61A functions as a locking pin that locks the displacement of the printer unit 50 in the X direction. A plurality of plungers 61A of the restriction mechanism 61 are provided for each printer unit 50.

As described above, the printing apparatus 10 according to the present disclosed technology includes the housing 11, the plurality of printer units 50, and at least one accommodation tray 34 (an example of an accommodation portion) that attachably and detachably accommodates at least one of the plurality of printer units 50 and that is displaceable with respect to the housing 11. Therefore, since the accommodation tray 34 is displaced with respect to the housing 11, the printer unit 50 is easily attached and detached as compared to the related art. That is, in the related art, the printer unit is attached to a rail provided on an inner wall of the housing. Therefore, in the related art, it is necessary to insert a hand into a narrow space in the housing in order to attach and detach the printer unit 50. However, in the printing apparatus 10, since the accommodation tray 34 that is displaced with respect to the housing 11 is provided, it is easy to access the printer unit 50. As a result, the attachment and detachment work of the printer unit 50 is simplified.

In addition, in the printing apparatus 10, the accommodation tray 34 that is an example of the accommodation portion can accommodate the plurality of printer units 50. Since the plurality of printer units 50 can be accommodated in one accommodation tray 34, the printer units 50 are easily attached and detached as compared to a case where one printer unit 50 is provided in one accommodation tray 34.

In addition, the accommodation tray 34 has an accommodation space that accommodates the plurality of printer units 50. That is, since the plate 41 has an area for accommodating the plurality of printer units 50, the plurality of printer units 50 can be stably accommodated. The plate 41 may have an area smaller than a total area of the plurality of printer units 50 to be accommodated. For example, the printer unit 50 may be accommodated by a lattice-shaped frame or the like.

In addition, the printing apparatus 10 includes a plurality of accommodation trays 34 that are examples of the accommodation portion. Since the plurality of accommodation trays 34 are provided, for example, it is possible to selectively use the accommodation tray 34 for each type of the printer unit 50, which is convenient.

In addition, in the printing apparatus 10, the accommodation tray 34 that is an example of the accommodation portion includes the adjustment mechanism 56 that is capable of adjusting according to the type of the printer unit 50. Therefore, since the printer unit 50 having different body sizes or body shapes can be accommodated, the usability is favorable. For example, in a case where the sizes or types of the recording medium 21 are different, the body size or the body shape of the printer unit 50 may be different. Therefore, it is possible to use the plurality of types of printer units 50 by the adjustment mechanism 56. In addition, in a case where a commercially available product is used as the printer unit 50, the printer unit 50 is not specifically designed for the printing apparatus 10, and thus the adjustment mechanism 56 is particularly effective.

It should be noted that, instead of providing the adjustment mechanism 56, the plurality of accommodation trays 34 may be configured to accommodate different types of printer units 50. Further, in a case where the accommodation space in which the plurality of printer units 50 can be accommodated is provided in one accommodation tray 34, different types of printer units 50 may be accommodated in each accommodation space. As described above, by devising the accommodation tray 34 in addition to providing the adjustment mechanism 56, it is possible to selectively use the plurality of accommodation trays 34 according to the type.

In addition, in the printing apparatus 10, since the accommodation portion is the accommodation tray 34, the configuration can be simplified.

In addition, the accommodation tray 34 is a drawer type that is pulled out from a storage position in the housing 11 to an attachment/detachment position to the outside of the housing 11. Since the accommodation tray 34 is the drawer type, the accommodation tray 34 linearly moves, and thus the configuration can be simplified and the design can be facilitated as compared to a case of rotational movement. For example, as the accommodation portion, an openable and closable door may be provided instead of the drawer type accommodation tray. In a case of the door, a rotation shaft is required, and thus the shape and the like of the housing 11 are also likely to be restricted. From the viewpoint of simplifying the configuration, the accommodation tray 34 is advantageous.

In addition, in the printing apparatus 10, the pulling-out direction (DR2 in FIG. 4) of the accommodation tray 34 is the same as the discharge direction (DR1 in FIG. 4) in which the accommodated printer unit 50 discharges the recording medium 21. With this configuration, it is possible to reduce the installation space as compared to a case where the pulling-out direction and the discharge direction are different. For example, in a case of considering the installation space of the housing 11, it is necessary to secure a space in which the recording medium 21 is discharged in the discharge direction. By matching the discharge direction and the pulling-out direction of the accommodation tray 34, the installation space other than the space for discharge can be suppressed.

In addition, in a case where the accommodation portion is constituted by the door, the door rotates, and thus the opening and closing direction of the door and the discharge direction of the recording medium 21 cannot be the same. Therefore, in a case of the door, a space for opening and closing the door is required in addition to the discharge direction. For such reasons, the configuration in which the pulling-out direction of the accommodation tray 34 and the discharge direction of the recording medium 21 are the same is advantageous in terms of space saving.

In addition, in the printing apparatus 10, the printer unit 50 is attached to the accommodation tray 34 in a posture in which the recording surface 21A of the recording medium 21 to be discharged faces the front side of the housing 11. Therefore, since the recording surface 21A of the recording medium 21 during discharge can face the user 18 who stands in a posture facing the front surface 11F of the housing 11, the user 18 can easily visually recognize the recording surface 21A.

In addition, in the printing apparatus 10, the plurality of printer units 50 are arranged in the height direction of the housing 11. By arranging the plurality of printer units 50 in the height direction, for example, in a case where a printer unit 50 from which to discharge the recording medium 21 is to be selected, there is an advantage that the printer unit 50 having a height according to the height of the user 18 can be selected.

In addition, in the printing apparatus 10, the accommodation trays 34 (an example of the accommodation portion) are respectively provided on both side surfaces 11S of the housing 11. Since the accommodation tray 34 is provided on both sides, for example, the number of accommodation trays can be increased as compared to a case where the accommodation tray 34 is provided on one side.

The accommodation tray 34 (an example of the accommodation portion) includes the restriction mechanism 61 that restricts the displacement of the printer unit 50. As a result, the unintended displacement of the printer unit 50 in the accommodation tray 34 can be restricted. In addition, the restriction mechanism 61 is a locking mechanism and includes a plurality of plungers 61A (an example of a locking pin), and, for example, the plunger 61A is provided for each printer unit 50.

In the above example, an example in which the plurality of accommodation trays 34 are provided has been described. However, only one accommodation tray 34 may be provided. In addition, an example in which the plurality of printer units 50 are accommodated in the accommodation tray 34 has been described. However, only one printer unit 50 may be accommodated in one accommodation tray 34. In addition, the housing 11 of the printing apparatus 10 is not limited to a housing divided into an upper housing and a lower housing, and may be a single housing.

In addition, an example in which the plurality of printer units 50 are accommodated in the accommodation tray 34 has been described. However, a part of the plurality of printer units 50 may be accommodated in the accommodation tray 34. Of course, it is preferable that all of the plurality of printer units 50 are accommodated.

In addition, various modifications can be made to the accommodation portion of the printing apparatus 10 as shown in the following various modification examples. In each of the following modification examples, the difference from the above-described embodiment will be mainly described, and the description of the common parts will be omitted.

### Modification Example 1

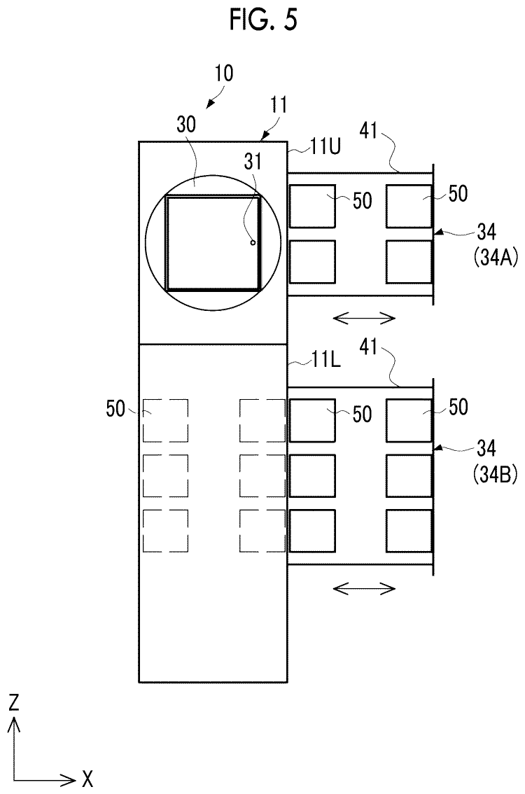

As shown in FIG. 5, the accommodation tray 34 may be provided only on one side of the housing 11. In Modification Example 1 shown in FIG. 5, unlike the example shown in FIG. 3, the accommodation tray 34 is provided only on the right side as viewed from the front of the housing 11. The accommodation tray 34 is pulled out on the right side as viewed from the front. The four printer units 50 are arranged in a matrix of two rows and two columns in the accommodation tray 34A of the upper housing 11U, and the six printer units 50 are arranged in a matrix of three rows and two columns in the accommodation tray 34B of the lower housing 11L. In each of the accommodation trays 34A and 34B, the discharge direction of the recording medium 21 of the printer unit 50 on the right side is the right side of the housing 11, and the discharge direction of the two printer units 50 on the left side is the left side of the housing 11.

### Modification Example 2

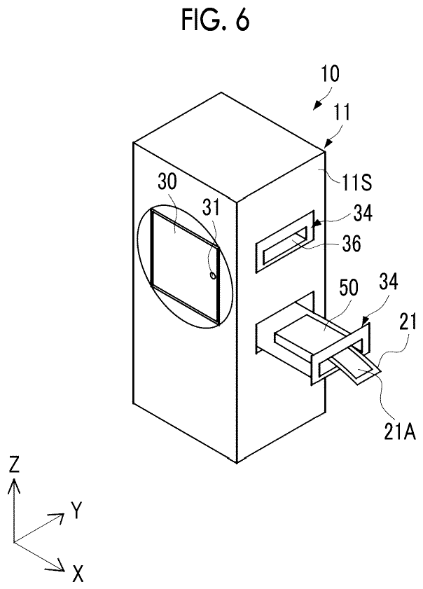

In addition, as in Modification Example 2 shown in FIG. 6, the posture of the accommodation tray 34 may be a posture obtained by rotating the posture shown in FIG. 2 around an axis in the X direction by 90°. In this case, the orientation of the recording surface 21A of the recording medium 21 discharged by the printer unit 50 is directed upward of the housing 11. The housing 11 of the printing apparatus 10 shown in FIG. 6 is not divided into an upper housing and a lower housing, and is one housing.

### Modification Example 3

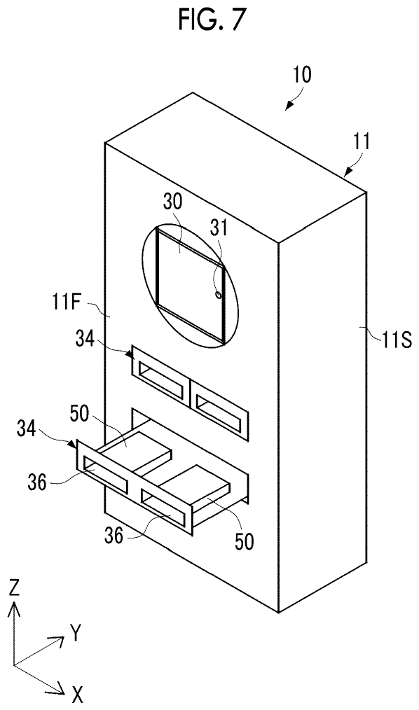

In addition, as in Modification Example 3 shown in FIG. 7, the accommodation tray 34 may be provided on the front surface 11F of the housing 11. In the example shown in FIG. 7, the accommodation trays 34 are provided in two stages of upper and lower stages, and two printer units 50 are accommodated in each stage of the accommodation tray 34.

### Modification Example 4 1

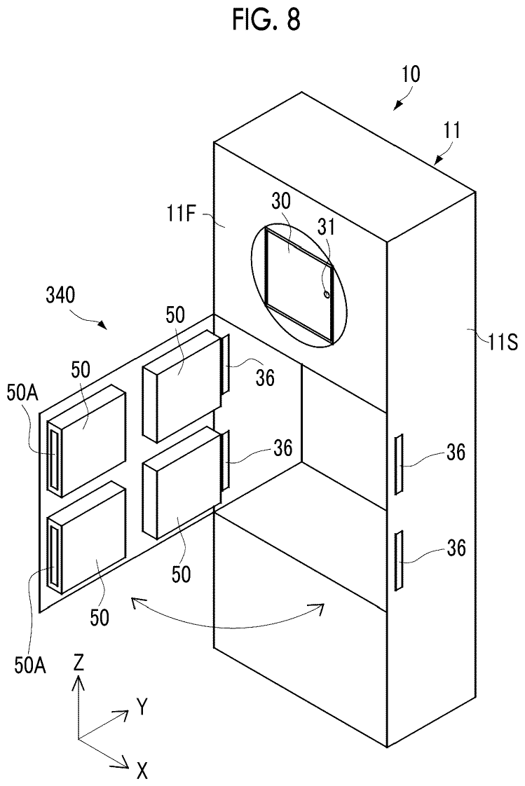

In addition, as in Modification Example 4 shown in FIG. 8, the accommodation portion may be an openable and closable door 340. The hinge of the door 340 is provided on one side surface 11S side of the housing 11. In the example shown in FIG. 8, the hinge of the door 340 is provided on the left side of the housing 11 as viewed from the front. The door 340 is, for example, opened and closed by rotating around an axis extending in the height direction (that is, the Z direction) of the housing 11. The door 340 is provided on the front surface 11F of the housing 11, and four printer units 50 are attachably and detachably accommodated inside the door 340. As an example, four printer units 50 are arranged in a matrix of two rows and two columns in the door 340. The discharge port 36 is provided on both side surfaces 11S of the housing 11. The discharge port 50A of the printer unit 50 faces the discharge port 36 in a state in which the door 340 is closed.

### Modification Example 5

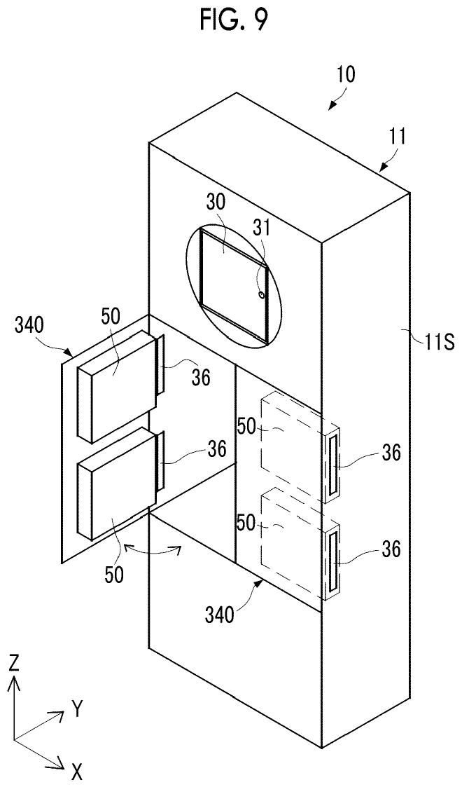

In addition, as in Modification Example 5 shown in FIG. 9, there may be two doors 340. In Modification Example 5 shown in FIG. 9, the respective hinges of the two doors 340 are provided on the right side and the left side of the housing 11 as viewed from the front. Two printer units 50 are attachably and detachably accommodated in each door 340.

### Modification Example 6

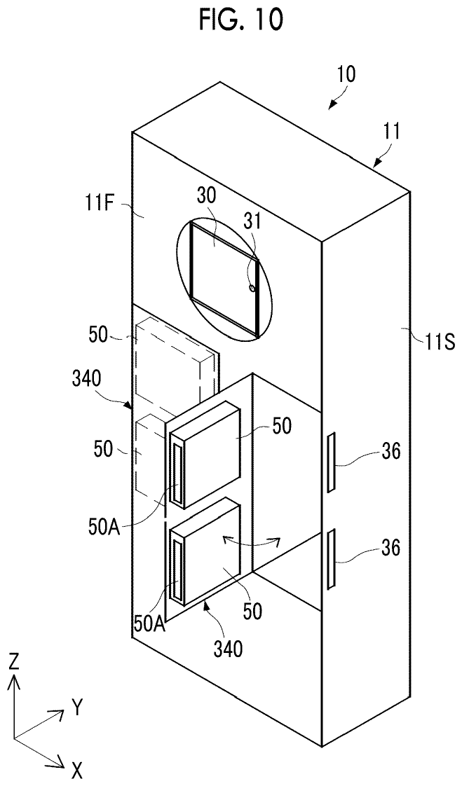

In addition, as in Modification Example 6 shown in FIG. 10, the respective hinges of the two doors 340 may be provided near the center of the housing 11.

### Modification Example 7

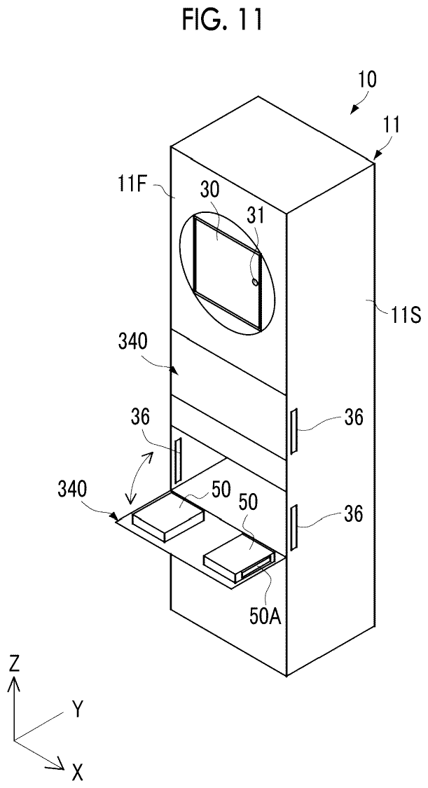

In addition, as in Modification Example 7 shown in FIG. 11, the door 340 may be opened and closed by rotating around an axis along the width direction (that is, the X direction) of the housing 11. The hinge of the door 340 is provided at a lower end of the door 340, and an upper end side of the door 340 rotates. As a result, the door 340 is opened to fall forward of the housing 11. In Modification Example 7 shown in FIG. 11, as an example, the door 340 has two stages, and two printer units 50 are attachably and detachably accommodated in each door 340.

In addition, for example, accommodating portions of various configurations may be used in combination, such as the accommodation tray 34 and the door 340.

The following supplementary notes are disclosed with regard to the above-described embodiment.

### Supplementary Note 1

A printing apparatus including:
a housing;
a plurality of printer units; and
at least one accommodation portion that attachably and detachably accommodates at least one of the plurality of printer units and that is displaceable with respect to the housing.

### Supplementary Note 2

The printing apparatus according to Supplementary Note 1, in which the accommodation portion is capable of accommodating the plurality of printer units.

### Supplementary Note 3

The printing apparatus according to Supplementary Note 2, in which the accommodation portion includes an accommodation space that accommodates the plurality of printer units.

### Supplementary Note 4

The printing apparatus according to any one of Supplementary Notes 1 to 3, further including:
a plurality of the accommodation portions.

### Supplementary Note 5

The printing apparatus according to any one of Supplementary Notes 1 to 4, in which the accommodation portion includes an adjustment mechanism that is capable of adjusting according to a type of the printer unit.

### Supplementary Note 6

The printing apparatus according to any one of Supplementary Notes 1 to 5, in which the accommodation portion is a tray or an openable and closable door.

### Supplementary Note 7

The printing apparatus according to Supplementary Note 6, in which the tray is a drawer type.

### Supplementary Note 8

The printing apparatus according to Supplementary Note 6 or 7, in which a plurality of the trays or the doors, which are selectively used according to a type are provided.

### Supplementary Note 9

The printing apparatus according to Supplementary Note 8, in which a direction in which the tray is pulled out is the same as a discharge direction in which the printer unit accommodated in the tray discharges a recording medium.

### Supplementary Note 10

The printing apparatus according to Supplementary Note 9, in which the printer unit is attached to the accommodation portion in a posture in which a recording surface of the recording medium to be discharged faces a front side of the housing.

### Supplementary Note 11

The printing apparatus according to any one of Supplementary Notes 1 to 10, in which the plurality of printer units are arranged in a height direction of the housing.

### Supplementary Note 12

The printing apparatus according to any one of Supplementary Notes 1 to 11 , in which the accommodation portions are respectively provided on both side surfaces of the housing.

### Supplementary Note 13

The printing apparatus according to any one of Supplementary Notes 1 to 12, in which the accommodation portion includes a restriction mechanism that restricts displacement of the printer unit.

### Supplementary Note 14

The printing apparatus according to Supplementary Note 13, in which the restriction mechanism is a locking mechanism, and includes a plurality of locking pins.

In the technology of the present disclosure, the above-described various embodiments and/or various modification examples can also be combined with each other as appropriate. In addition, it goes without saying that the present disclosure is not limited to each of the embodiments described above, various configurations can be adopted as long as the configuration does not deviate from the gist.

The above-described contents and the above-shown contents are the detailed description of the parts according to the technology of the present disclosure, and are merely an example of the technology of the present disclosure. For example, the above description of the configuration, the function, the operation, and the effect are the description of examples of the configuration, the function, the operation, and the effect of the parts according to the technology of the present disclosure. Accordingly, it goes without saying that unnecessary parts may be deleted, new elements may be added, or replacements may be made with respect to the above-described contents and the above-shown contents within a range that does not deviate from the gist of the technology of the present disclosure. In order to avoid complications and facilitate grasping the parts according to the technology of the present disclosure, in the above-described contents and the above-shown contents, the description of technical general knowledge and the like that do not particularly require description for enabling the implementation of the technology of the present disclosure is omitted.

In the present specification, “A and/or B” has the same meaning as “at least one of A or B”. That is, “A and/or B” means that A alone may be used, B alone may be used, or a combination of A and B may be used. In addition, in the present specification, also in a case where three or more matters are expressed in association by “and/or”, the same concept as “A and/or B” is applied.

All of the documents, the patent applications, and the technical standards described in the present specification are incorporated herein by reference to the same extent as in a case where each of the documents, patent applications, and technical standards is specifically and individually described by being incorporated by reference.

What is claimed is:

1. A printing apparatus comprising:
a housing;
a plurality of printer units; and
at least one accommodation portion that attachably and detachably accommodates at least one of the plurality of printer units and that is displaceable with respect to the housing.

2. The printing apparatus according to claim 1,
wherein the accommodation portion is capable of accommodating the plurality of printer units.

3. The printing apparatus according to claim 2,
wherein the accommodation portion includes an accommodation space that accommodates the plurality of printer units.

4. The printing apparatus according to claim 1, further comprising:
a plurality of the accommodation portions.

5. The printing apparatus according to claim 1,
wherein the accommodation portion includes an adjustment mechanism that is capable of adjusting according to a type of the printer unit.

6. The printing apparatus according to claim 1,
wherein the accommodation portion is a tray or an openable and closable door.

7. The printing apparatus according to claim 6,
wherein the tray is a drawer type.

8. The printing apparatus according to claim 6,
wherein a plurality of the trays or the doors, which are selectively used according to a type are provided.

9. The printing apparatus according to claim 8,
wherein a direction in which the tray is pulled out is the same as a discharge direction in which the printer unit accommodated in the tray discharges a recording medium.

10. The printing apparatus according to claim 9,
wherein the printer unit is attached to the accommodation portion in a posture in which a recording surface of the recording medium to be discharged faces a front side of the housing.

11. The printing apparatus according to claim 1,
wherein the plurality of printer units are arranged in a height direction of the housing.

12. The printing apparatus according to claim 1,
wherein the accommodation portions are respectively provided on both side surfaces of the housing.

13. The printing apparatus according to claim 1,
wherein the accommodation portion includes a restriction mechanism that restricts displacement of the printer unit.

14. The printing apparatus according to claim 13,
wherein the restriction mechanism is a locking mechanism, and includes a plurality of locking pins.
